(19) United States
(12) Patent Application Publication
(10) Pub. No.: US 2026/0342850 A1
(43) Pub. Date: Oct. 29, 2026

(54) AUTHENTICATION WITH TCP SYN PACKETS

(71) Applicant: Raytheon Company, Arlington, VA (US)

(72) Inventor: Frederick K. Jones, Tucson, AZ (US)

(21) Appl. No.: 19/191,777

(22) Filed: Apr. 28, 2025

(51) Int. Cl. H04L 9/40; H04L 69/16

(52) U.S. Cl. CPC H04L 63/1491; H04L 63/0236; H04L 63/0838; H04L 63/1458; H04L 69/16

(57) ABSTRACT

Systems, devices, methods, and computer-readable media for computer security using transmission control protocol (TCP) header configuration. A method can include receiving, by a receiver device and from a sender device, a transmission control protocol (TCP) packet with a header that includes (i) a synchronization (SYN) flag set to true, (ii) an acknowledgement (ACK) flag set to false, and (iii) an acknowledgement number field to a validation value, responsive to verifying that the SYN flag, ACK flag, and acknowledgement number field are set to true, false, and an expected validation value, respectively, issuing, by the receiver device and to the sender device, a SYN ACK packet, and responsive to the verifying, establishing a communication channel between the sender device and the receiver device.

### GOVERNMENT RIGHTS

This invention was made with government support under contract N66001-24-C-4504 awarded by the Naval Information War Center, Pacific. The government has certain rights in the invention.

### BACKGROUND

Network services are readily discoverable via domain name service (DNS) entries and standardized port numbers. In fact, the entire internet protocol (IP) version 4 (v4) internet can be scanned completely in less than 30 days. In fact, some businesses have leveraged this ability to scan the internet to sell databases of vulnerable services with geotagging. Using this scanning of the internet, sensitive software services can be discovered and then attacked. Spoofed (fake) source IP addresses can cause denial of service (DoS) attacks during transmission control protocol (TCP)/IP synchronization (SYN) handshake. Today, a server always acknowledges the presence of its port-based services.

### BRIEF DESCRIPTION OF DRAWINGS

FIG. 1 illustrates, by way of example, a communication flow diagram of a typical TCP/IP packet connection establishment or termination.

FIG. 2 illustrates, by way of example, a flow diagram of an embodiment of a denial of service (DoS) attack.

FIG. 3 illustrates, by way of example, a diagram of an embodiment of a system that includes TCP/IP synchronization authentication.

FIG. 4 illustrates, by way of example, a diagram of an embodiment of a method for authentication using a TCP SYN packet.

FIG. 5 illustrates, by way of example, a diagram of an embodiment of a method for authentication using a TCP SYN packet.

FIG. 6 illustrates, by way of example, a block diagram of an embodiment of a machine in the example form of a computer system within which instructions, for causing the machine to perform any one or more of the methodologies discussed herein, may be executed.

### DETAILED DESCRIPTION

The following description and the drawings sufficiently illustrate teachings to enable those skilled in the art to practice them. Other embodiments may incorporate structural, logical, electrical, process, and other changes. Portions and features of some examples may be included in, or substituted for, those of other examples. Teachings set forth in the claims encompass all available equivalents of those claims.

A transmission control protocol (TCP)/internet protocol (IP) packet header structure is provided for foundational understanding.

TABLE 1
TCP/IP Packet Header Format as defined in request
for comment (RFC) 675 and RFC 793, among others.

| | |
|---|---|
| SOURCE PORT | DESTINATION PORT |

SEQUENCE NUMBER
ACKNOWLEDGMENT NUMBER

| | | | | | | | | | | |
|---|---|---|---|---|---|---|---|---|---|---|
| DATA | RES. | CWR | ECE | URG | ACK | PSH | RST | SYN | FIN | WINDOW |
| OFF- | | | | | | | | | | |
| SET | | | | | | | | | | |

| | |
|---|---|
| CHECKSUM | URGENT POINTER |

OPTIONS
DATA
. . .

The TCP/IP header structure includes a plurality of fields including fields pertinent to this application. The fields pertinent to this application include the acknowledgment number, ACK flag, and SYN flag. Other fields are explained just to provide a better overall understanding of the context in which the subject matter is used.

A source port field identifies the port of a device that initiated the TCP/IP packet generation and transmission. A destination port field identifies a receiving port. A sequence number field has a dual role. If a SYN flag is set (1), then this is an initial sequence number. The sequence number of the actual first data byte and the acknowledged number in a corresponding ACK are then this sequence number plus 1. If the SYN flag is unset (0), then this is the accumulated sequence number of the first data byte of this segment for the current session.

If the ACK flag is set then the value of the acknowledgement number field is the next sequence number that the sender of the ACK is expecting. This acknowledges receipt of all prior bytes (if any). The first ACK sent by each end acknowledges the other end's initial sequence number itself, but no data.

The data offset specifies the size of the TCP header in 32-bit words. The minimum size header is 5 words and the maximum is 15 words thus giving the minimum size of 20 bytes and maximum of 60 bytes, allowing for up to 40 bytes of options in the header.

Reserved (Res.) is for future use. Flags consume 8 bits and contains 8 1-bit flags (control bits) as follows:

Congestion window reduced (CWR) flag is set by the sending host to indicate that it received a TCP segment with an explicit connection notification echo (ECE) flag set and had responded in congestion control mechanism.

The ECE flag informs a sender that a network is experiencing congestion.

An urgent (URG) flag indicates that an urgent pointer field is significant.

An acknowledge (ACK) flag indicates that the Acknowledgment field is significant.

A push function (PSH) flag asks to push the buffered data to the receiving application.

A reset (RST) flag resets a connection between the sender and the receiver.

The SYN flag synchronizes sequence numbers. Only a first packet sent from each end should have this flag set. Some other flags and fields change meaning based on this flag, and some are only valid when it is set, and others when it is clear (0).

A final (FIN) flag indicates that the current packet is a last packet from a sender.

Those are the flags in TCP/IP header packets. The window field indicates a size of the receive window, which specifies the number of window size units that the sender of this segment is currently willing to receive. The checksum field is used for error-checking of the TCP header, the payload and an IP pseudo-header. The pseudo-header consists of the source IP address, the destination IP address, the protocol number for the TCP protocol, and the length of the TCP headers and payload (in bytes). The urgent pointer field indicates that, if the URG flag is set, then this field is an offset from the sequence number indicating the last urgent data byte.

An options field, the length of which is determined by the data offset field, includes option-kind, option-length, and option-data. The option-kind field indicates the type of option. Depending on option-kind value, the next two fields may be set. Option-length indicates the total length of the option, and option-data contains data associated with the option, if applicable. A final data field indicates a payload of the TCP packet.

Embodiments repurpose the ACK value field in the TCP/IP header to be an authentication code. This value is sent with the SYN flag set (=true) and an ACK flag clear (=false) (invalid value field). The code can be generated from a Pseudo-Random Number Generator (PRNG). The authentication code can be generated using a time-based one-time password (TOTP) scheme (as with Rivest-Shahir-Adleman (RSA) securID tokens). An example TOTP is described in RFC 6238. Alternatively, the authentication code can be generated from True Random Number Generation (TRNG) sources and stored during device enrollment. In some embodiments, the receiver computes the expected ACK value by using the Sequence Number to compute an index into the precomputed TRNG table.

The time-based one-time password scheme, such as RSA SecurID tokens, provide hardware or software-based security used for two-factor authentication. The time-based one-time password scheme provides an extra layer of security beyond just a password. These tokens generate a unique, time-based passcode (also called a “tokencode”) that changes every 60 seconds. Users enter this passcode, along with a password or other code, to verify their identity when accessing protected resources.

Using embodiments, if the value in the ACK number field sent from the client (e.g., a browser of the client) to the server in the initial SYN packet is not expected or zero, the server discards the packet and the port appears (to the client) to be unbound. Alternatively, if the ACK number field sent from the client to the server during the initial SYN packet is invalid or zero, the client can be connected to a honeypot and/or tarpit (false, resource intensive services for active defense & deception).

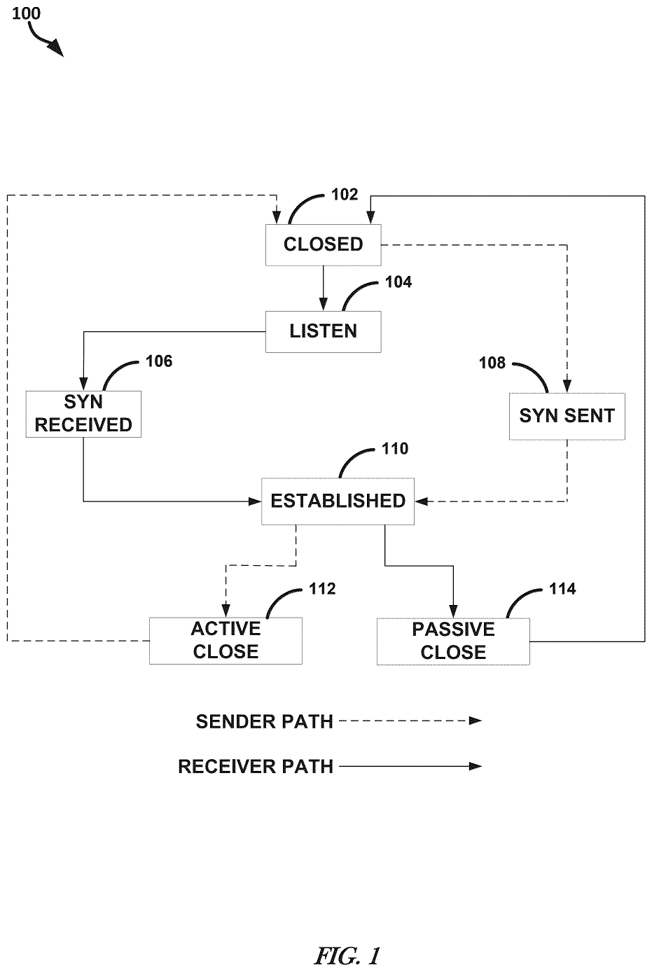

FIG. 1 illustrates, by way of example, a communication flow diagram of a typical TCP/IP packet connection establishment or termination. TCP protocol operations may be divided into three phases: connection establishment, data transfer, and connection termination. Connection establishment is a multi-step handshake process that establishes a connection before entering the data transfer phase. After data transfer is completed, the connection termination closes the connection and releases all allocated resources. The TCP connection is managed by an operating system (OS) through a resource that represents the local end-point for communications, the internet socket. During the lifetime of a TCP connection, the local end-point undergoes a series of state changes which are labeled in FIG. 1. Pertinent to this application is the connection establishment phase.

All connections start in a closed state 102. Before a sender device attempts to connect with a server, the server must first bind to and listen 104 at a port to open it up for connections, this is called a passive open. After the passive open is established, a client (sometimes called the “sender device”) may establish a connection by initiating an active open using a handshake. The handshake can include sending a TCP packet header with a SYN flag set and a sequence number field set to a value (e.g., a random value) being sent 108. The SYN packet is received 106 by the server.

In response, to receiving the SYN packet, the server replies with a SYN-ACK packet. The acknowledgment number of the SYN-ACK packet is set to one more than the received sequence number (e.g., the random number plus one), and the sequence number that the server chooses for the packet is a second random number.

Finally, the client sends an ACK packet back to the server. The sequence number of the ACK packet is set to the received acknowledgment value (the second random number plus one).

The SYN and SYN-ACK packets establish and acknowledge the sequence number for one direction (client to server (sometimes called the “receiver device”). The following SYN-ACK and ACK packets establish and acknowledge the sequence number for the other direction (server to client). Following the completion of these steps, both the client and server have received acknowledgments and a full-duplex communication is established 110.

The connection can be actively closed 112 or passively closed 114. The active close 112 and passive close 114 are not important for the subject matter of this application.

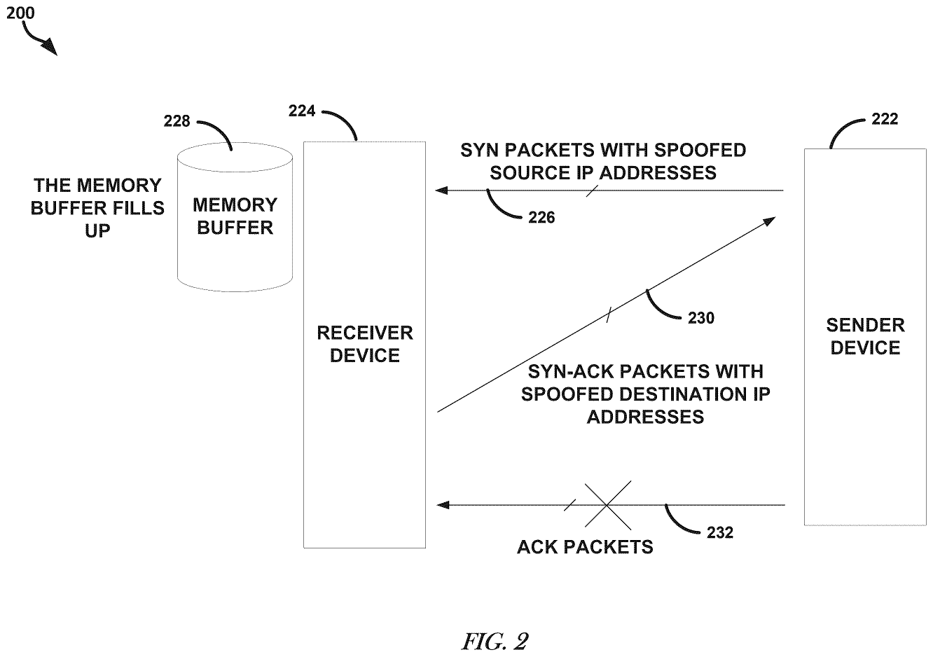

FIG. 2 illustrates, by way of example, a flow diagram of an embodiment of a denial of service (DoS) attack 200. The DoS attack 200 includes one or more attacker hosts 222 issuing a plurality of SYN packets 226 to a receiver device 224 server. The plurality of SYN packets 226 includes spoofed source IP addresses and spoofed destination IP addresses. The receiver device 224 includes a memory buffer 228 that stores the source IP addresses, destination IP addresses, other information in the SYN packets 226, or a combination thereof. The memory buffer 228 begins to fill up as the data from the SYN packets 226 is stored in the memory buffer 228. When the memory buffer fills up to the point where it can no longer store any of the SYN packets 226, the receiver device 224 can no longer offer services to any clients due to lack of available memory. This is why it is called a DoS attack.

In a typical transport control protocol (TCP)/internet protocol (IP) communication session, a TCP SYN packet 226 is stored in the memory buffer 228. The receiver device 224 issues a SYN-ACK packet 230 responsive to the SYN packet 226. Then the attacker host 222 responds with an ACK packet 232.

Embodiments can prevent the DoS attack by requiring SYN packets to have a valid authentication code. The authentication code can be provided in the acknowledgement number field when the ACK flag is set to false and the SYN flag is set to true. Usually, in this configuration, the receiver device 224 would ignore the acknowledgment number field, because the ACK flag is set to false. However, with a programming change, the receiver device 224 can be configured to search for this flag configuration. Then, responsive to detecting the flag configuration, the receiver device 224 can verify whether the acknowledgement number field contains a valid authentication code. Responsive to confirming a valid authentication code, the receiver device 224 can continue to open a connection with the client. Responsive to confirming an invalid authentication code, the receiver device 224 can discard the packet, making it look like the port is closed, or forward the packet to a honeypot. Either way, the receiver device 224 is no longer a victim of a DoS attack.

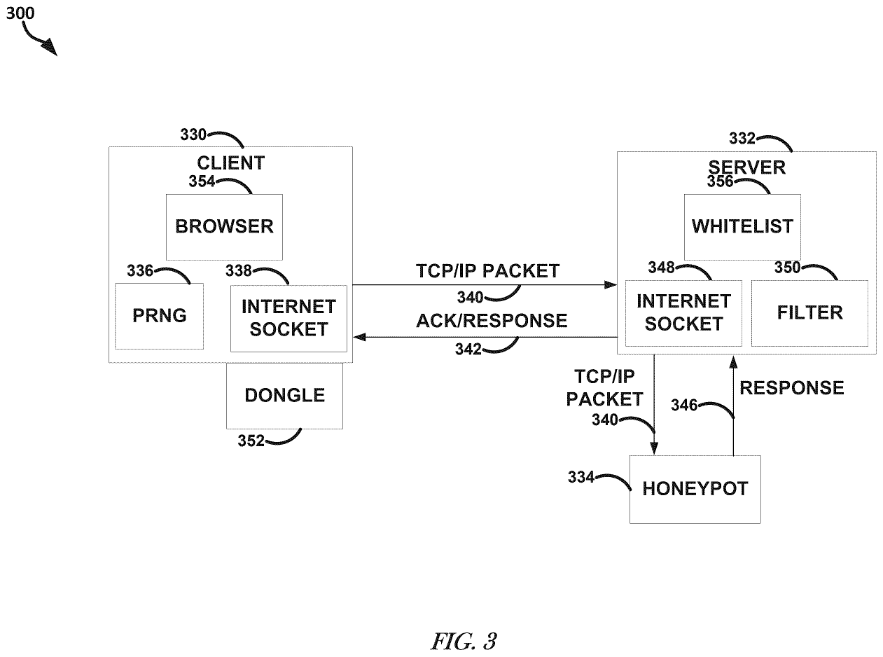

FIG. 3 illustrates, by way of example, a diagram of an embodiment of a system 300 that includes TCP/IP synchronization authentication. The system 300 is configured to prevent DoS attacks. The system 300 as illustrated includes the client 330, server 332, and an optional honeypot 334. More generally, the client 330 could be referred to as a sender and the server 332 could be referred to as a receiver. The client 330 includes a pseudorandom number generator 336 and an internet socket 338. The PRNG 336 can be a part of an authentication program that provides a time-dependent value to the internet socket 338. The internet socket 338 assembles a TCP/IP packet 340. The internet socket 338 is an endpoint for communication between applications. The internet socket 338 can generate the TCP/IP packet 340 to include a SYN flag set to true, ACK flag set to false, and an acknowledgement number filed with a value determined based on a random number generated by the PRNG 336.

The server 332 can receive the TCP/IP packet 340, such as at another internet socket 348. The internet socket 348 can be configured to look for a SYN packet (a TCP/IP packet with the SYN flag set to true and the ACK flag set to false). Responsive to identifying TCP/IP packet 340 is a SYN packet, the internet socket 348 can further be configured to compare the value in the acknowledgement number field to a validation code. If the value matches the validation code, the internet socket 348 can generate an ack packet 342 and provide the ack packet 342 to the client 330. If the value does not match the validation code, the internet socket 348 can either discard the TCP/IP packet 340 making it look like the port is closed or forward the TCP/IP packet 340 to the honeypot 334.

The honeypot 334 can be a virtual service operating on a machine separate from the server 332. The honeypot 334 can emulate being the server 332. The honeypot 334 can act like it is the server 332 and that it is the destination for the TCP/IP packet 340. The honeypot 334 can generate a response 346 that is expected by the client 330. The server 332 can then send the response 346 to the client 330. In this way, the client 330 believes it is communicating with the server 332 and the server 332 is performing the steps required to cause a DoS error. This makes the client 330 continue to use its resources trying to cause a DoS error without successfully causing the DoS error.

Note that the internet socket 348 can be configured to compare the acknowledgement field value for only specified destination or source addresses. The internet socket 348 can thus be further configured to identify SYN packets from specific source addresses. In this configuration, the internet socket 348 can only compare the value in the acknowledgement number field of SYN packets from specified source addresses to an expected validation code. The internet socket 348 can then handle the packet 340 as discussed previously. The value expected in the acknowledgement number field can be dependent upon the destination port. Each service on the receiver can have a unique expected cryptographic value associated with it.

Some OSs allow a user to alter the TCP/IP packet header. For example, a Linux Kernel Module (LKM) allows the user to alter the TCP/IP packet header. Some OSs do not allow a user to configure the internet socket 338. Devices exist that can bypass the OS and/or internet socket 338. Such a device, as illustrated, is a dongle 352. The dongle 352 is a device that can be plugged into the client 330, such as through a universal serial bus (USB) port. The dongle 352 provides functionality that is not allowed by the OS of the client 330, such as an ability to alter (and communicate) the TCP/IP packet 340 to the server 332. The dongle 352 can establish a TCP/IP communication channel with the server 332 and then handoff the communication channel to an internet browser 354 of the client 330. The handoff can be achieved through application layer logic. The internet browser 354 can then take over the communication channel and communicate as an authenticated application.

The handoff can include a pre-shared encryption key (PSK) used for client-server communications (including potentially ephemeral keys). The dongle 352 can send the browser a configuration data package that includes IP addresses, ports, and encryption keys to use for communicating with the server 332. This is generated after the SYN-phase ACK number value authentication.

On the server 332, a filter 350, such as an extended Berkeley packet filter (ePBF), can be added to the server 332. The filter 350 can inspect the ACK number field value for correctness. If the value is incorrect, the connection can be transparently rerouted to the honeypot 334 running on a different port.

The value in the acknowledgment number filed can be a time-based one-time password (TOTP) value. The TOTP value can be used to select PSK encryption key for client-server communication.

Responsive to verifying a validation code in the acknowledgement number field, the server 332 can dynamically add the IP address of the client 330 to a whitelist 356 (which may or may not implement the SYN-phase ACK value authentication mechanism). The client 330 can then communicate with the server 332 in the future without needing to re-validate using the SYN packet.

The solutions provided herein do not rely on new TCP Options (does not change the size of the packet), and uses lightweight (quantum resistant) PRNG algorithms appropriate for embedded IOT devices. Usually, the ACK value field is only read when the ACK validity flag is true. The intended purpose of the field is to acknowledge received packets by echoing the matching sequence value. Embodiments use the field for a purpose that it was not designed for, namely validation when the ACK flag value is set to false. This allows the server 332 to (falsely) claim a service does not exist (thus it is a hidden/covert service) and even that an IP address is not active at all. Such a mechanism subverts IP scanning mechanisms and makes it seem like the server 332 does not exist and keeps the server 332 of the DNS lists generated by the scanning services. Further, the mechanism also enables two services to exist-one for benign users and the other as a honeypot by creating a “virtual port” and rewriting network connections based on SYN authentication. The mechanism enables creating “honeyservices” on the same infrastructure as benign users thus enabling potentially more scalable deception techniques. By hindering service discovery and network enumeration, cyberattacks can be halted at the Reconnaissance phase (see MITRE ATT&CK Matrix).

The client 330 can include a devices that integrates TCP/IP web services such as embedded/IOT devices that use web services and remote login for configuration and status information. This includes printers, security cameras, critical infrastructure, manufacturing systems, network switches, medical devices, device to device authentication generally, among others.

Seeing non-zero values in the TCP/IP ACK value during initial SYN with the server 332 is non-standard and readable as plaintext with standard network analysis applications. The sender can be configured to communicate with the receiver by scanning a quick response (QR) code on an internet of things (IOT) device with the associated smart phone app. This approach will require updates to current commercial operating systems to enable SYN-phase authentication. Alternatively, an attached dongle can support the SYN phase authentication capability.

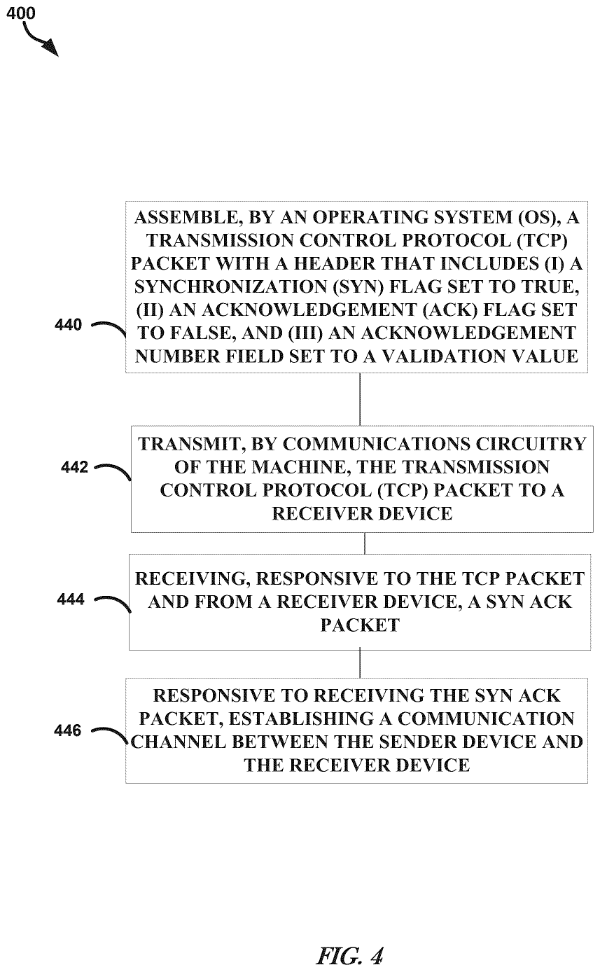

FIG. 4 illustrates, by way of example, a diagram of an embodiment of a method 400 for authentication using a TCP SYN packet. The method 400 as illustrated includes assembling, by an operating system (OS), a transmission control protocol (TCP) packet with a header that includes (i) a synchronization (SYN) flag set to true, (ii) an acknowledgement (ACK) flag set to false, and (iii) an acknowledgement number field set to a validation value, at operation 440; transmitting, by communications circuitry of the machine, the transmission control protocol (TCP) packet to a receiver device, at operation 442; receiving, responsive to the TCP packet and from a receiver device, a SYN ACK packet, at operation 444; and responsive to receiving the SYN ACK packet, establishing a communication channel between the sender device and the receiver device, at operation 446.

The sender device can include a dongle communicatively coupled thereto and the TCP packet is assembled by an OS of the dongle. The method 400 can further include handing off, by the dongle, the communication channel to an internet browser of the sender device. The validation value can be a time-based one-time password. The validation value can include a preloaded table of random numbers and wherein the sender removes a used random number from the table after successful authentication to prevent replay attacks.

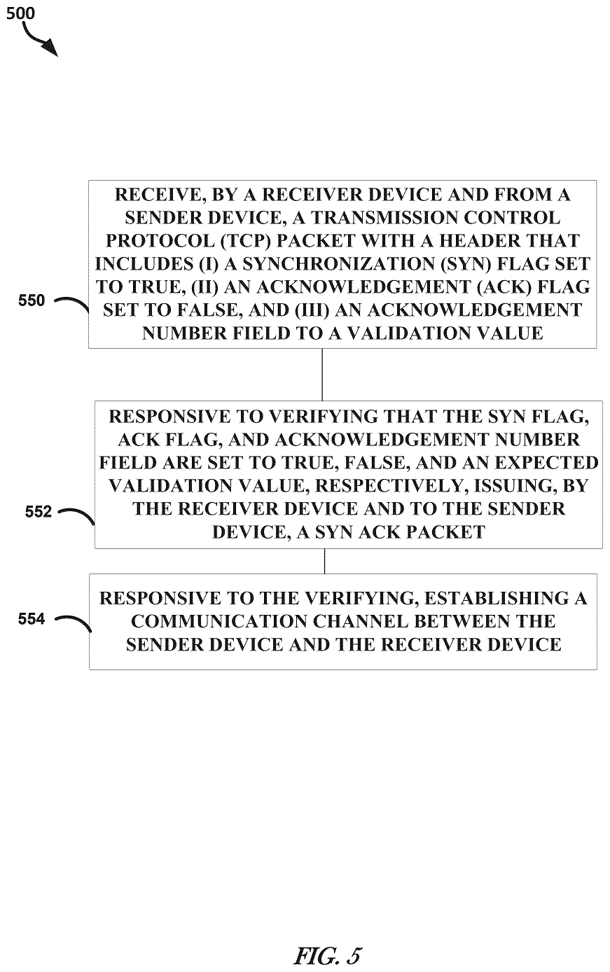

FIG. 5 illustrates, by way of example, a diagram of an embodiment of a method 500 for authentication using a TCP SYN packet. The method 500 as illustrated includes receiving, by a receiver device, a transmission control protocol (TCP) packet with a header that includes (i) a synchronization (SYN) flag set to true, (ii) an acknowledgement (ACK) flag set to false, and (iii) an acknowledgement number field to a validation value, at operation 550; responsive to verifying that the SYN flag, ACK flag, and acknowledgement number field are set to true, false, and an expected validation value, respectively, issuing, by the receiver device, a SYN ACK packet, at operation 552; and responsive to the verifying, establishing a communication channel between a sender device of the TCP packer and the receiver device, at operation 554.

The method 500 can further include responsive to the verifying, adding an internet protocol (IP) address in a source field of the TCP packet to a whitelist. The method 500 can further include responsive to receiving a second TCP packet from the sender device, verifying that the source field of the second TCP packet indicates the IP address on the whitelist and establishing another communication channel between the sender and the receiver device. The method 500 can further include responsive to determining that the SYN flag, ACK flag, or acknowledgement number field is not set to true, false, and the expected validation value, respectively, discarding the TCP packet so it appears to the sender device that the receiver device is not present.

The method 500 can further include responsive to determining that the SYN flag, ACK flag, or acknowledgement number field is not set to true, false, and the expected validation value, respectively, forwarding the TCP packet to a honeypot that emulates being the receiver device. The validation value can be a time-based one-time password. The validation value can include a preloaded table of random numbers and wherein the sender removes a used random number from the table after successful authentication to prevent replay attacks.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules may provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus (e.g., a programmable processor, a computer, or multiple computers).

A computer program may be written in any form of programming language, including compiled or interpreted languages, and it may be deployed in any form, including as a stand-alone program or as a module, subroutine, or other unit suitable for use in a computing environment. A computer program may be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations may also be performed by, and apparatus of example embodiments may be implemented as, special purpose logic circuitry, e.g., a field programmable gate array (FPGA) or an application-specific integrated circuit (ASIC).

The computing system may include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium (e.g., Storage Device)

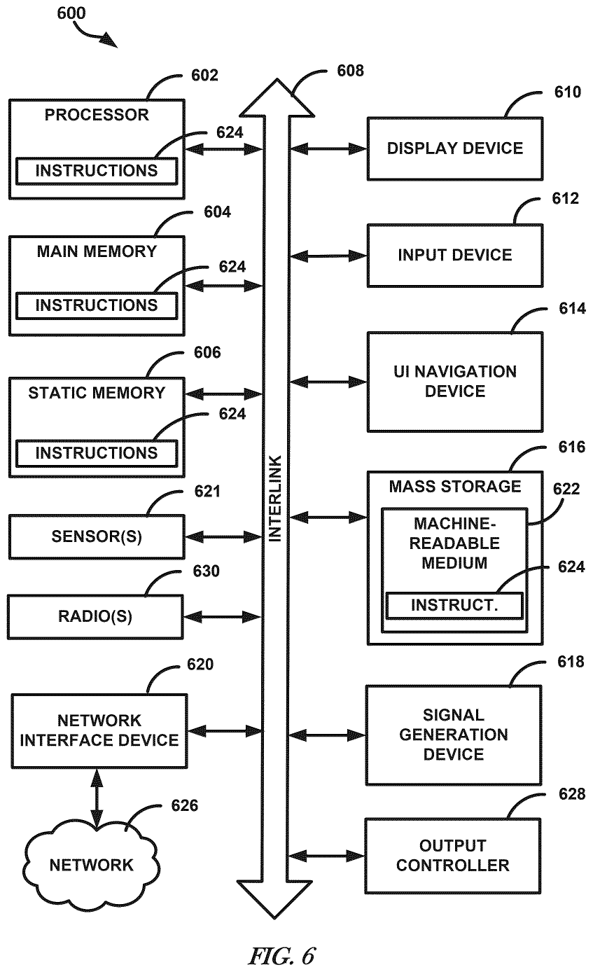

FIG. 6 illustrates, by way of example, a block diagram of an embodiment of a machine in the example form of a computer system 600 within which instructions, for causing the machine to perform any one or more of the methodologies discussed herein, may be executed. One or more of the operations or components of the system 300 or method 400, 500 can be implemented or performed by the computer system 600. A device, such as the client 330 (sender device), server (receiver device) 332, honeypot 334, or the like, can include one or more components of the computer system 600. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., processing circuitry, such as can include a central processing unit (CPU), a graphics processing unit (GPU), field programmable gate array (FPGA), other circuitry, such as one or more transistors, resistors, capacitors, inductors, diodes, regulators, switches, multiplexers, power devices, logic gates (e.g., AND, OR, XOR, negate, etc.), buffers, memory devices, sensors 621 (e.g., a transducer that converts one form of energy (e.g., light, heat, electrical, mechanical, or other energy) to another form of energy), such as an IR, SAR, SAS, visible, or other image sensor, or the like, or a combination thereof), or the like, or a combination thereof), a main memory 604 and a static memory 606, which communicate with each other via a bus 608. The memory 604, 606 can store parameters (sometimes called weights) that define operations of the processing circuitry 602, or other component of the system 600. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation device 614 (e.g., a mouse), a disk drive unit 616, a signal generation device 618 (e.g., a speaker), a network interface device 620, and radios 630 (or other communications circuitry) such as Bluetooth, WWAN, WLAN, and NFC, permitting the application of security controls on such protocols.

The machine 600 as illustrated includes an output controller 628. The output controller 628 manages data flow to/from the machine 600. The output controller 628 is sometimes called a device controller, with software that directly interacts with the output controller 628 being called a device driver.

### Machine-Readable Medium

The disk drive unit 616 includes a machine-readable medium 622 on which is stored one or more sets of instructions and data structures (e.g., software) 624 embodying or utilized by any one or more of the methodologies or functions described herein. The instructions 624 may also reside, completely or at least partially, within the main memory 604, the static memory 606, and/or within the processor 602 during execution thereof by the computer system 600, the main memory 604 and the processor 602 also constituting machine-readable media.

While the machine-readable medium 622 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding, or carrying instructions for execution by the machine, and includes digital or analog communications signals or other intangible media to facilitate communication of such software.

### ADDITIONAL EXAMPLE

Example 1 can include a method (performed by a receiver device) comprising receiving, by a receiver device and from a sender device, a transmission control protocol (TCP) packet with a header that includes (i) a synchronization (SYN) flag set to true, (ii) an acknowledgement (ACK) flag set to false, and (iii) an acknowledgement number field to a validation value, responsive to verifying that the SYN flag, ACK flag, and acknowledgement number field are set to true, false, and an expected validation value, respectively, issuing, by the receiver device and to the sender device, a SYN ACK packet, and responsive to the verifying, establishing a communication channel between the sender device and the receiver device.

In Example 2, Example 1 further includes responsive to the verifying, adding an internet protocol (IP) address in a source field of the TCP packet to a whitelist.

In Example 3, Example 2 further includes responsive to receiving a second TCP packet from the sender device, verifying that the source field of the second TCP packet indicates the IP address on the whitelist and establishing another communication channel between the sender and the receiver device.

In Example 4, at least one of Examples 1-3 further includes responsive to determining that the SYN flag, ACK flag, or acknowledgement number field is not set to true, false, and the expected validation value, respectively, discarding the TCP packet so it appears to the receiver that the sender device is not present.

In Example 5, at least one of Examples 1~4 further includes responsive to determining that the SYN flag, ACK flag, or acknowledgement number field is not set to true, false, and the expected validation value, respectively, forwarding the TCP packet to a honeypot that emulates being the receiver device.

In Example 6, at least one of Examples 1-5 further includes, wherein the validation value is a time-based one-time password.

In Example 7, at least one of Examples 1-6 further includes, wherein the validation value includes a preloaded table of random numbers and wherein the sender removes a used random number from the table after successful authentication to prevent replay attacks.

In Example 8, a receiver device or a machine-readable medium are configured to perform the method of one of Examples 1-7.

In Example 9, a system includes a sender device comprising first processing circuitry, a first memory comprising instructions that, when executed by the first processing circuitry, cause the first processing circuitry to perform first operations comprising transmitting, by communications circuitry, a transmission control protocol (TCP) packet with a header that includes (i) a synchronization (SYN) flag set to true, (ii) an acknowledgement (ACK) flag set to false, and (iii) an acknowledgement number field to a validation value, and a receiver device comprising second processing circuitry, and a second memory comprising instructions that, when executed by the second processing circuitry, cause the second processing circuitry to perform second operations comprising receiving, from the sender device, the TCP packet, verifying that the SYN flag, ACK flag, and acknowledgement number field are set to true, false, and an expected validation value, respectively, responsive to the verifying, issuing, to the sender device, a SYN ACK packet, and responsive to the verifying, establishing a communication channel between the sender device and the receiver device.

In Example 10, Example 9 further includes, wherein the second operations further comprise responsive to the verifying, adding an internet protocol (IP) address in a source field of the TCP packet to a whitelist.

In Example 11, at least one of Examples 9-10 further includes responsive to receiving a second TCP packet from the sender device, verifying that the source field of the second TCP packet indicates the IP address on the whitelist and establishing another communication channel between the sender and the receiver device.

In Example 12, at least one of Examples 9-11 further includes, wherein the second operations further comprise responsive to determining that the SYN flag, ACK flag, or acknowledgement number field is not set to true, false, and the expected validation value, respectively, discarding the TCP packet so it appears to the receiver device that the sender device is not present.

In Example 13, at least one of Examples 9-12 further includes, wherein the second operations further comprise responsive to determining that the SYN flag, ACK flag, or acknowledgement number field is not set to true, false, and the expected validation value, respectively, forwarding the TCP packet to a honeypot that emulates being the receiver device.

In Example 14, at least one of Examples 9-13 further includes, wherein the sender device includes a dongle communicatively coupled thereto and the first operations further comprise establishing, by the dongle, the communication channel and then handing off the communication channel to an internet browser of the sender device.

In Example 15, at least one of Examples 8-15 further includes, wherein the validation value is a time-based one-time password.

In Example 16, at least one of Examples 8-16 further includes, wherein the validation value includes a preloaded table of random numbers and wherein the sender removes a used random number from the table after successful authentication to prevent replay attacks.

In Example 17, a method or multiple machine-readable media are configured to perform the method of one of Examples 1-7.

Example 18 includes a non-transitory machine-readable medium including instructions that, when executed by a machine (a sender device), cause the machine to perform operations for computer security using transmission control protocol (TCP) header configuration, the operations comprising assembling, by an operating system (OS), a transmission control protocol (TCP) packet with a header that includes (i) a synchronization (SYN) flag set to true, (ii) an acknowledgement (ACK) flag set to false, and (iii) an acknowledgement number field set to a validation value, transmitting, by communications circuitry of the machine, the transmission control protocol (TCP) packet to a receiver device, receiving, responsive to the TCP packet and from a receiver device, a SYN ACK packet, and responsive to receiving the SYN ACK packet, establishing a communication channel between the sender device and the receiver device.

In Example 19, Example 18 further includes, wherein the sender device includes a dongle communicatively coupled thereto and the TCP packet is assembled by an OS of the dongle.

In Example 20, at least one of Examples 18-19 further includes, wherein the operations further comprise handing off, by the dongle, the communication channel to an internet browser of the sender device.

In Example 21, at least one of Examples 18-20 further includes, wherein the validation value is a time-based one-time password.

In Example 22, at least one of Examples 18-21 further includes, wherein the validation value includes a preloaded table of random numbers and wherein the sender removes a used random number from the table after successful authentication to prevent replay attacks.

In Example 23, a sender device or a method are configured to perform the operations of the machine-readable medium of one of Examples 18-22.

Although teachings have been described with reference to specific example teachings, it will be evident that various modifications and changes may be made to these teachings without departing from the broader spirit and scope of the teachings. Accordingly, the specification and drawings are to be regarded in an illustrative rather than a restrictive sense. The accompanying drawings that form a part hereof, show by way of illustration, and not of limitation, specific teachings in which the subject matter may be practiced. The teachings illustrated are described in sufficient detail to enable those skilled in the art to practice the teachings disclosed herein. Other teachings may be utilized and derived therefrom, such that structural and logical substitutions and changes may be made without departing from the scope of this disclosure. This Detailed Description, therefore, is not to be taken in a limiting sense, and the scope of various teachings is defined only by the appended claims, along with the full range of equivalents to which such claims are entitled.

What is claimed is:

1. A method comprising:
receiving, by a receiver device, a transmission control protocol (TCP) packet with a header that includes (i) a synchronization (SYN) flag set to true, (ii) an acknowledgement (ACK) flag set to false, and (iii) an acknowledgement number field to a validation value;
responsive to verifying that the SYN flag, ACK flag, and acknowledgement number field are set to true, false, and an expected validation value, respectively, issuing, by the receiver device, a SYN ACK packet; and
responsive to the verifying, establishing a communication channel between a sender device of the TCP packet and the receiver device.

2. The method of claim 1, further comprising responsive to the verifying, adding an internet protocol (IP) address in a source field of the TCP packet to a whitelist.

3. The method of claim 2, further comprising responsive to receiving a second TCP packet from the sender device, verifying that the source field of the second TCP packet indicates the IP address on the whitelist and establishing another communication channel between the sender and the receiver device.

4. The method of claim 1, further comprising responsive to determining that the SYN flag, ACK flag, or acknowledgement number field is not set to true, false, and the expected validation value, respectively, discarding the TCP packet so it appears to the sender device that the receiver device is not present.

5. The method of claim 1, further comprising responsive to determining that the SYN flag, ACK flag, or acknowledgement number field is not set to true, false, and the expected validation value, respectively, forwarding the TCP packet to a honeypot that emulates being the receiver device.

6. The method of claim 1, wherein the validation value is a time-based one-time password.

7. The method of claim 1, wherein the validation value includes a preloaded table of random numbers and wherein the sender removes a used random number from the table after successful authentication to prevent replay attacks.

8. A system comprising:
a sender device comprising:
first processing circuitry; and
a first memory comprising instructions that, when executed by the first processing circuitry, cause the first processing circuitry to perform first operations comprising:
transmitting, by communications circuitry, a transmission control protocol (TCP) packet with a header that includes (i) a synchronization (SYN) flag set to true, (ii) an acknowledgement (ACK) flag set to false, and (iii) an acknowledgement number field to a validation value; and
a receiver device comprising:
second processing circuitry; and
a second memory comprising instructions that, when executed by the second processing circuitry, cause the second processing circuitry to perform second operations comprising:
receiving, from the sender device, the TCP packet;
verifying that the SYN flag, ACK flag, and acknowledgement number field are set to true, false, and an expected validation value, respectively,
responsive to the verifying, issuing, to the sender device, a SYN ACK packet; and
responsive to the verifying, establishing a communication channel between the sender device and the receiver device.

9. The system of claim 8, wherein the second operations further comprise responsive to the verifying, adding an internet protocol (IP) address in a source field of the TCP packet to a whitelist.

10. The system of claim 9, further comprising responsive to receiving a second TCP packet from the sender device, verifying that the source field of the second TCP packet indicates the IP address on the whitelist and establishing another communication channel between the sender and the receiver device.

11. The system of claim 8, wherein the second operations further comprise responsive to determining that the SYN flag, ACK flag, or acknowledgement number field is not set to true, false, and the expected validation value, respectively, discarding the TCP packet so it appears to the receiver device that the sender device is not present.

12. The system of claim 8, wherein the second operations further comprise responsive to determining that the SYN flag, ACK flag, or acknowledgement number field is not set to true, false, and the expected validation value, respectively, forwarding the TCP packet to a honeypot that emulates being the receiver device.

13. The system of claim 8, wherein the sender device includes a dongle communicatively coupled thereto and the first operations further comprise establishing, by the dongle, the communication channel and then handing off the communication channel to an internet browser of the sender device.

14. The system of claim 8, wherein the validation value is a time-based one-time password.

15. The system of claim 8, wherein the validation value includes a preloaded table of random numbers and wherein the sender removes a used random number from the table after successful authentication to prevent replay attacks.

16. A non-transitory machine-readable medium including instructions that, when executed by a machine, cause the machine to perform operations for computer security using transmission control protocol (TCP) header configuration, the operations comprising:
assembling, by an operating system (OS), a transmission control protocol (TCP) packet with a header that includes (i) a synchronization (SYN) flag set to true, (ii) an acknowledgement (ACK) flag set to false, and (iii) an acknowledgement number field set to a validation value;
transmitting, by communications circuitry of the machine, the transmission control protocol (TCP) packet to a receiver device;
receiving, responsive to the TCP packet and from a receiver device, a SYN ACK packet; and
responsive to receiving the SYN ACK packet, establishing a communication channel between a sender device and the receiver device.

17. The non-transitory machine-readable medium of claim 16, wherein the sender device includes a dongle communicatively coupled thereto and the TCP packet is assembled by an OS of the dongle.

18. The non-transitory machine-readable medium of claim 17, wherein the operations further comprise handing off, by the dongle, the communication channel to an internet browser of the sender device.

19. The non-transitory machine-readable medium of claim 16, wherein the validation value is a time-based one-time password.

20. The non-transitory machine-readable medium of claim 16, wherein the validation value includes a preloaded table of random numbers and wherein the sender removes a used random number from the table after successful authentication to prevent replay attacks.
